(19) United States
(12) Patent Application Publication
(10) Pub. No.: US 2010/0057493 A1
(43) Pub. Date: Mar. 4, 2010

(54) Method for Independent Compliance Certification and Training

(76) Inventor: Wendy Heckelman, Weston, FL (US)

Correspondence Address: ROBERT M. SCHWARTZ, P.A., P.O. BOX 221470, HOLLYWOOD, FL, 33022, US

(21) Appl. No.: 12/552,514

(22) Filed: Sep. 2, 2009

Related U.S. Application Data
(60) Provisional application No. 61/093,493, filed on Sep. 2, 2008.
(60) Provisional application No. 61/150,360, filed on Feb. 6, 2009.

(51) Int. Cl. G06Q 10/00; G06Q 50/00; G06Q 90/00

(52) U.S. Cl. 705/2; 705/11; 705/7; 705/500

(57) ABSTRACT

A system and method are provided that trains and monitors the activities of company professionals with health care providers. The system and method additionally take into account the new requirements for certification and documentation of compliance assessment, training, monitoring or reporting. Additionally, the system and method can be customized, if desired, to at least one of a particular product, a particular company and a particular field or industry.

The present application claims priority from co-pending U.S. Provisional Patent Application Ser. No. 61/150,360, filed on Feb. 6, 2009, and from U.S. Provisional Patent Application Ser. No. 61/093,493, filed on Sep. 2, 2008, both entitled METHOD FOR INDEPENDENT COMPLIANCE CERTIFICATION AND TRAINING, those applications being incorporated herein, by reference, in their entireties.

### BACKGROUND OF THE INVENTION

1. Field of the Invention

The invention relates to a system and method to assess, train and field-monitor contact between a corporate professional and a health care provider utilizing industry guidelines and standards, and applicable federal and state laws.

2. Description of the Related Art

There are several evolving factors that continue to change the environment and requirements for Pharmaceutical Sales Professionals. These factors include: external scrutiny and litigation facing the industry; federal guidelines; state legislation; local restrictions; public perceptions of the pharmaceutical industry's conduct; and internal and external audit requirements.

There is a well-known and active interface between pharmaceutical companies and medical providers. Recently, various industry guidelines have been adopted by the pharmaceutical industry to define and regulate the type of conduct engaged in between pharmaceutical company sales, marketing, and medical professionals and healthcare providers.

One such guideline was issued by the U.S. Pharmaceutical Retailers and Manufacturers Association (PhRMA). Their PhRMA Code is a voluntary, industry standard of rules relating, among other things, to the certification and documentation of compliance training of all pharmaceutical professionals. The rules provide that all professionals should be informed and trained in matters of industry laws, regulations, and codes of practice that relate to pharmaceutical professional interaction with healthcare professionals.

### SUMMARY OF THE INVENTION

It is accordingly an object of the invention to provide a system and method that trains and monitors the activities of company professionals with health care providers. In one particular embodiment of the present invention, the system and method additionally take into account new code requirements for certification and documentation of compliance training and assessment. In one particular embodiment of the invention, the system and methods of the instant invention are additionally customized to at least one of a particular product, a particular company and a particular field or industry.

Other features which are considered as characteristic for the invention are set forth in the appended claims.

Although the invention is illustrated and described herein as embodied in a method for independent compliance certification and training, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 is a high level flow diagram illustrating the main steps of the procedure of the present invention in accordance with one particular embodiment of the present invention;

FIG. 2 is a flow diagram illustrating the procedure for the customization of the tools and processes of the present invention for a client in accordance with one particular embodiment of the present invention;

FIG. 3 is a flow diagram illustrating the procedure and systems for providing Web-Enabled Knowledge Training and Testing in accordance with one particular embodiment of the present invention;

FIG. 4 is a flow diagram illustrating the procedure for delivering the Behavioral Learning Cascade in accordance with one particular embodiment of the present invention;

FIG. 5 is a flow diagram illustrating the procedure for administering the Behavioral Observation Audit in accordance with one particular embodiment of the present invention;

FIG. 6 is a flow diagram illustrating the steps in calculating Sales Professional Certification scores in accordance with one particular embodiment of the present invention;

FIG. 7 is a flow diagram illustrating the procedure for Annual Re-Certification in accordance with one particular embodiment of the present invention;

FIG. 8 is a flow diagram illustrating the main steps of the Field Based Monitoring procedure in accordance with one particular embodiment of the present invention;

FIG. 9 is a flow diagram illustrating the customization of tools and processes in the Field Based Monitoring procedure in accordance with one particular embodiment of the present invention;

FIG. 10 is a flow diagram illustrating the Behavioral Learning Cascade of the Field Based Monitoring procedure in accordance with one particular embodiment of the present invention; and

FIG. 11 is a flow diagram illustrating the main steps of a Behavioral Observation Audit of the Field Based Monitoring procedure in accordance with one particular embodiment of the present invention;

### DESCRIPTION OF THE PREFERRED EMBODIMENTS

The present invention addresses the needs of regulatory compliance training and oversight by providing a system and method that trains and monitors the activities of company professionals with health care providers. The present invention also addresses new code requirements for certification and documentation of compliance training and assessment, such as the new PhRMA code requirements.

Overview:

In particular, the system and method provided herein ensures that sales professionals are knowledgeable and can display compliant behavior by training and updating professionals on regulations and guidelines pertaining to compliant interactions with healthcare professionals, including detailing speaker and educational program requirements and formulary interactions. The system is customizable at the product level to provide legally-sustainable evidence that an organization is meeting its obligation to ensure compliant behavior. The invention creates an organization-wide framework for on-going coaching, learning, and evaluation that sets boundaries up-front for appropriate marketing messages and sales practices.

In many organizations, compliance issues are typically handled by a relatively small group. However, the system of the present invention can be used to spread the accountability and oversight to a larger group of participants through training and updates focused on clarifying individual and group roles and responsibilities relating to compliance.

Under one particular embodiment of the instant invention, the training is administered via a Learning Cascade that directs appropriate training and information to all levels of management and field professionals. In this embodiment, the role clarification includes instruction on appropriate oversight and monitoring of compliance training and implementation. The preparation of managers further involves preparing managers to assess sales professionals through a behavioral audit customized by company and product and a certification and monitoring process for Sales Managers and Professionals on compliant interaction knowledge and behavior. The Behavioral Observation Audit portion of the invention tests the knowledge and behavior skills required for compliant interaction with healthcare professionals.

As part of the inventive system, managers in an organization will complete regular Behavioral Observation Audits for each direct report during field observations, which includes observation of professional-health care provider interactions. These audits will assess mastery of compliant selling behaviors, knowledge, and skills. The audits also provide managers with specific exemplary behavioral examples to move sales professionals from “adherence-to-rules” to “best practices” status.

Behavioral Observation Audit results are recorded in the system and disseminated throughout the organization for evaluation and any necessary modifications relating to sales professionals behavior and instruction on changes in compliance rules. Any company-specific reporting requirements are defined and implemented in the Behavioral Observation Audit. For example, reporting processes can allow sales leadership to identify trends and/or specific trouble spots, and immediately respond to proactively mitigate risk.

The web-enabled structure in the present invention allows for flexible, focused reporting and updating. There are also optionally utilized ongoing coaching tools to enhance sales success.

The system and method of the present invention will also provide for the development and launch of computer based, web-enabled assessment and monitoring processes. The web enabled system can be used to generate reports for compliance, senior management (i.e., marketing, medical, and sales), and others, as determined to the organization. These reports may be transmitted, via a network server, to appropriate personnel. Such transmissions can take a variety of forms, including, but not limited to, emails, text messages, wireless alerts, Blackberry/Smartphone downloads and combinations of the foregoing.

By focusing heavily on application and clarity of “good” practices, individuals operating under the system and method of the invention are trained to understand what “appropriate” or “compliant” means, in practice. Additionally, the information provided by the system and method of the invention also allows for quick response to changes in the competitive market and compliance environments.

The customizable aspects of the present invention integrate the latest regulatory compliance information available to bridge the gap between existing training programs and changing compliance requirements. The customizable aspects include the ability to update the system in response to regulatory changes as well as the ability to add specific training materials targeted to a specific product, company and/or medical specialty. Additionally, the customizable aspects of the system of the present invention provide the ability to combine existing company programs and training with the training, assessment, and coaching tools of the present invention.

In particular, the system and method of the present invention help pharmaceutical organizations achieve customer-centric goals with a focus on providing value to healthcare providers; provide sales leadership (Field, District, State, and/or Regional Directors, Marketing and Medical Managers, and Vice Presidents) with tools for conducting behavioral observation assessments with an ongoing coaching and feedback process; and provide an early warning of potential compliance missteps that promotes early action to prevent any widespread confusion.

Companies that utilize the present invention will create a compliant culture by transferring knowledge into every aspect of work to support behavioral change; empowering line leaders to take accountability for and commit to creating a “culture of compliance;” and providing skills to coach teams on compliant selling behaviors. Thus the instant invention achieves the desired “compliant culture” by providing the specific tools described herein that reinforce application and compliance sustainability by utilizing leader-led Learning modules and field Coaching Guides.

Glossary of Defined Terms:

The following definitions are given to facilitate understanding of the system and method of the present invention:

VP/Sales Leader—employees of a company including, but not limited to, senior leaders from business units, sales, marketing, legal, and compliance;

Regional Manager—employees of a company including, but not limited to, managers with responsibility for sales teams where these teams consist of field managers or District Managers and their direct reports or Sales Professionals;

District Manager—employees of a company including, but not limited to, direct supervisors of a team of field sales representatives or Sales Professionals;

Sales Manager—a Regional Manager, District Manager or another employee with supervisory responsibility over sales team members;

Sales Professional—employees of a company including, but not limited to, sales representatives who have direct contact with Healthcare Providers;

Registered User—any employee of a company who has completed the registration process of the present invention; and

Healthcare Providers—publically or privately employed individuals in the medical sciences field who interact with medical patients or have a substantial influence on the provision of care for medical healthcare patients including, but not limited to, physicians, physician assistants, pharmacists, administrators, formulary managers, and third party payers.

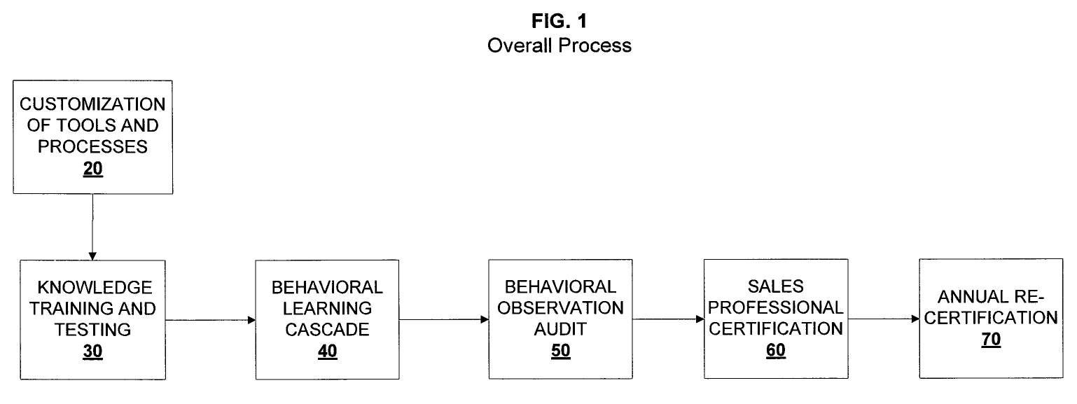

Referring now to FIG. 1, there is shown a flow diagram that outlines, at a high level, the use of the instant invention to create customized training and monitoring tools that enable the certification of pharmaceutical professionals' knowledge and behavior regarding applicable industry laws, regulations, and codes of practice. The overall system of the present embodiment of the instant invention will be described in connection with the associated subprocesses/subsystems including: the customization of tools and processes for a particular product, company and/or medical specialty/field (20); the knowledge training and testing system (30); the behavioral learning cascade (40); the behavioral observation audit (50); the sales professional certification (60); and the annual recertification system (70). Although illustrated as including the systems 20, 30, 40, 50, 60 and 70, the invention is not limited thereto, as more or fewer subsystems may be used. Additionally, as will be described more particularly herebelow, if desired, any of the systems 20, 30, 40, 50, 60 or 70 can be implemented as a stand-alone system, separate and apart from any of the other systems 20, 30, 40, 50, 60 or 70.

Further, in one particular embodiment of the instant invention, each of the systems 20, 30, 40, 50, 60 or 70 include modules that are implemented in memory on a computer of a computer system, such as a stand-alone computer system, a local or wide area computer network or, if desired, on a remote network accessible via direct communications and/or Internet. Each of the subsystems 20, 30, 40, 50, 60 and 70 will be described more particularly herebelow.

Customization of Tools and Processes:

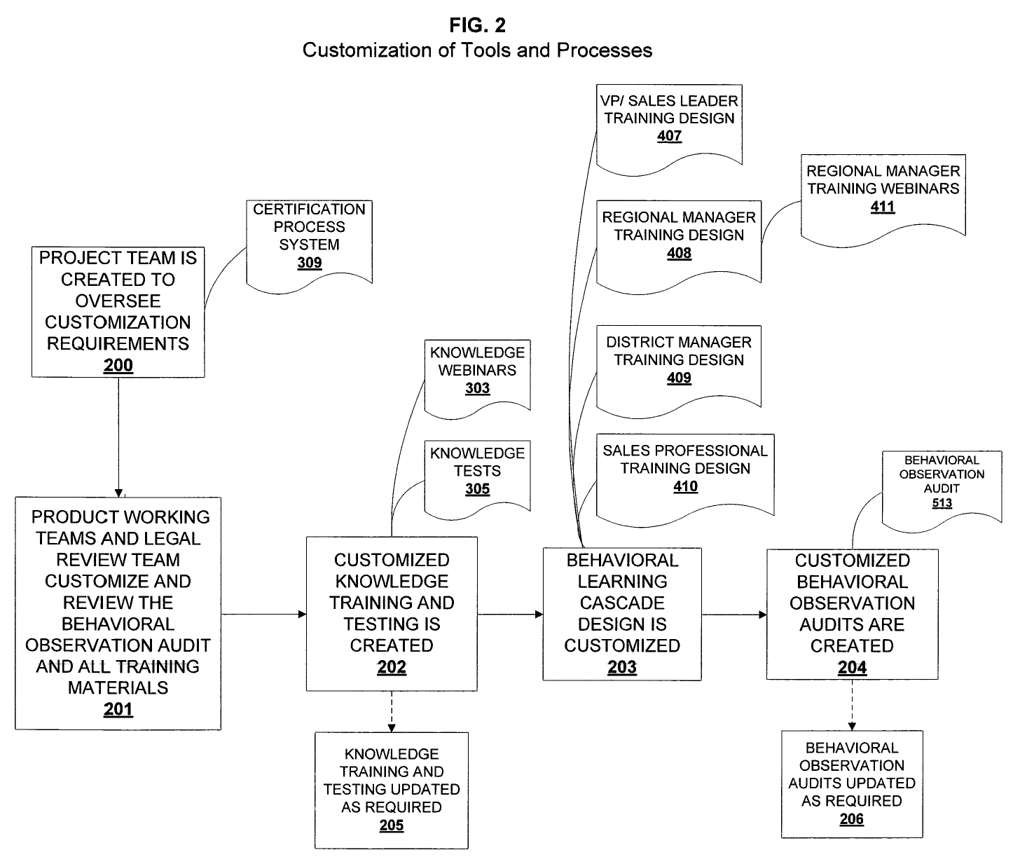

More particularly, the instant invention provides for the customization of tools and processes to a particular product, company and/or field or industry. Referring now to FIGS. 1 and 2, one particular embodiment of the procedure for the customization of tools and processes 20 will be described in more detail.

In order to customize the system of the instant invention for a particular product, company and/or field, a Project Team is first created to resolve open issues and oversee the customization requirements of the certification process (200 of FIG. 2). The Project Team members may include but are not limited to representatives from compliance, legal, sales operations, sales field force, marketing, human resources, training, and business unit leaders. Ideally, they will meet periodically throughout the course of the certification process to resolve issues related to customization, development, and execution. The issues to be resolved include issues related to the Certification Process System customization (309 of FIG. 2), integration and reporting; the determination of key metrics; and reporting requirements.

The Project Team will also make the key decisions regarding the Behavioral Learning Cascade 40 implementation and modifications including timing of training, training delivery modes, and training tool development and facilitation requirements. The Project Team can also determine the frequency of Behavioral Observation Audits 50 and the timing and implementation of Annual Re-Certification 70. The Project Team additionally determines customization requirements, including score cutoffs, for the Sales Professional Certification process 60. They also make key decisions regarding change management and communications plans, and oversee the final approval of all training and certification materials. For example, the Project Team would be capable of identifying and procuring any additional resources that would be required for certification process implementation.

The Certification Process System 309 includes a computer system that is used to host certain components of the Knowledge Training and Testing system 30, the Behavioral Observation Audit system 50, and Sales Professional Certification system 60 of the present invention. The Certification Process System 309 can be realized in computer software stored on a computer readable medium. If desired, the stored Certification Process System 309 can be configured (i.e., coded) as computer modules that are “Sharable Content Object Reference Model” (SCORM) and/or “Aviation Industry CBT [Computer-Based Training] Committee” (AICC) compliant.

SCORM is a collection of standards and specifications for web-based e-learning. SCORM is a specification of the Advanced Distributed Learning (ADL) Initiative, which comes out of the Office of the United States Secretary of Defense. It defines communications between client side content and a host system called the run-time environment (commonly a function of a learning management system or learning content management system). One of the primary purposes of the SCORM standards is to define interoperability between learning content and learning management systems. Through SCORM conformance, content packages and learning managements systems together achieve such interoperability.

A SCORM-conformant content package can be delivered via SCORM-conformant learning management systems and SCORM-conformant learning management systems can deliver SCORM-conformant content packages.

AICC guidelines are another set of standards that promote system interoperability. They were originally developed for the airline industry but have been widely adopted by CBT users outside this industry.

Customizable elements of the Certification Process System 309, include system linkages, access and security requirements, configuration and process specifications for the Knowledge Training and Testing system 30, Behavioral Observations Audit system 50, and Sales Professional Certification system 60, notifications and other communications, reporting, and “Help Desk” requirements. Such customization additionally can include the extent to which the Certification Process System 309 is, or is not, used for any of these processes. All Certification Process System 309 customization decisions are finalized by the Project Team. The computer modules forming the Certification Process System 309 can then be customized in accordance with the Project Team's determinations.

Additionally, if different from the Project Team, Product Working Teams and a Legal Review Team can also be formed to customize and review the Behavioral Observation Audit system 50 and all training materials (201 of FIG. 2). Product Working Teams customize the Knowledge Training materials 30, the Behavioral Learning Cascade 40, and the Behavioral Observation Audit 50 instruments and execution. Additionally, in the present embodiment of the invention, Product Working Teams are formed for each of a client's pharmaceutical products and may include, but are not limited to, representatives from sales operations, sales field force, product managers, and marketing with expert knowledge of that product. Product Working Teams can be utilized to review the Knowledge Training and Testing 30 content for customization needs, for example, for the additions of company-specific policies and validation of knowledge content. These teams also customize the Behavioral Observation Audit systems 513 for company and product-specific requirements. Such customization can include decisions on audit length and categories, identification of model behaviors for questions within the categories, and content validation of audit questions. They are also responsible for implementation decisions, for example, regarding whether and how to pilot test certification process tools and training. Target behaviors and content identified by the Product Working Teams are also used in the Behavioral Learning Cascade system 40 design and development.

In the instant embodiment, the Legal Review Teams formed in 201 include compliance and legal representatives from the company with sufficient product knowledge to identify the compliance standards for each product and category of the Behavioral Observation Audit. These Legal Review Teams also identify applicable content from Corporate Integrity Agreements (CIAs) with the government, other sales behavior restrictions and risks relating to interactions with healthcare providers at the product level, validate all certification training tools and content, and approve all certification process communications.

With input from the Product Working Teams and Legal Review Teams, the systems, questionnaires and/or software modules used in the Behavioral Observation Audit 50 can be customized for application to a particular product, company and/or field of use, as desired.

Similarly, with oversight from the Project Team, Product Working Teams, and the Legal Review Team, the content for the Knowledge Training and Testing is customized (202 of FIG. 2) and updated (205 of FIG. 2), as required. Additionally, customizations and modifications can be performed on the designs for the Behavioral Learning Cascades (203 of FIG. 2), the Behavioral Observation Audits 513 (204 of FIG. 2), and the Sales Professional Certification 60 and Annual Re-Certification 70 processes, as required. It is important to note that, although referred to periodically herein as “web-based Knowledge Training and Testing” or “web-enabled Knowledge Training and Testing”, such Knowledge Training and Testing is not limited to being “web-based”/“web-enabled”, as such can be incorporated on a LAN, WAN or other private network of a company (i.e., and not “web” based) and still be within the scope and intention of the instant invention. In other words, any type of network computer access, including Internet based and non-Internet based network computer access, is intended to be encompassed by the terms “Web-Based” and “Web-Enabled”, as used herein.

Referring back to FIGS. 1 and 2, part of the tools and processes customized during the customization (20 of FIG. 1) include the customization of knowledge webinars (303 of FIG. 2). The Knowledge Webinars 303 are files which integrate all federal laws, federal regulatory overview, industry guidelines, state requirements, and corporate guidelines pertaining to the interaction between sales representatives and healthcare providers. Sample content areas include: Federal Regulatory Overview; Detailing/Interactions; Product Management, Research, and Education Activities; and Consultants, Speakers, and Formulary Interactions. The total number of Knowledge Webinars will be dependent on the content customization requirements determined by the Product Working Teams and Legal Review Team. The Knowledge Webinars 303 combine state-of-the art e-learning features including voice-over that provides detailed explanation of content. Such Knowledge Webinars are on-line and/or downloadable, which enable the Webinars to be streamed or viewed off-line, for self-paced learning, as desired. Although described as “Webinars”, such can be accessible from the Internet or by Intranet—i.e., over a local or remote network by some communications means other than the Internet (i.e., LAN, WAN, telephone, etc.,). However, if desired, during the Customization of Tools and Processes 20, the Project Team may elect to modify the involvement of the Certification Process System 309 in the delivery of the Knowledge Webinars. For example, they may only be available on a limited company intranet system and not available for remote access.

Each Knowledge Webinar 303 has an accompanying Knowledge Test 304. Knowledge Test 304 construction employs best or exemplary practices to ensure valid test and certification process outcomes. For example, each Knowledge Test 304 is dynamically created from a large question pool stored in a computer database. All Knowledge Test 304 questions are validated by the Product Working Teams and Legal Review Teams. During the Customization of Tools and Processes 20, the Project Team also determines how, and from where, Knowledge Tests may be accessed.

The Designs for the Behavioral Learning Cascade of training to VP/Sales Leaders, Regional Managers, Field Managers (hereafter referred to as District Managers), and Sales Professionals contain the blueprints for delivering appropriate training to all levels of the sales organization in order to create a “culture of compliance” (407, 408, 409, 410, respectively, of FIG. 2). The VP/Sales Leader Training Design 407 includes the blueprint for training on the implications and behavioral applications of compliance regulations and policies and on how to provide oversight and direction for the certification process of the present invention. The Regional Manager Training Design 408 contains the blueprint for training District Managers on how to conduct the Behavioral Observation Audit and provide behavioral coaching on outstanding compliant selling skills to sales professionals. In one particular example, the design for the Regional Manager Training includes the use of two webinars 411.

The District Manager Training Design 409 contains the blueprint for training District Managers to deliver live behavioral training and ongoing feedback to sales professionals on compliant interaction skills and the use and administration of the Behavioral Observation Audit 513 and any sustainability tools identified by the Project Team for development. The Sales Professional Training Design 410 contains the blueprint for providing practice and feedback to Sales Professionals on how to apply compliance knowledge to real world field situations and to help them develop and improve compliant selling skills.

The VP/Sales Leader Training Design 407, the Regional Manager Training Design 408, the District Manager Training Design 409, and the Sales Professional Training Design 410 use leader-led learning to help managers transfer compliance understanding into every aspect of their work and ensure that knowledge and skills are reinforced and retained. Leader-led learning occurs because VP/Sales Leaders are involved in facilitating the training of Regional Managers and Regional Managers are involved in facilitating the training of District Managers. Leader-led learning also ensures that Regional Managers can audit the performance of District Managers and also conduct Behavioral Observation Audits of sales professionals, if required.

During the Customization Process 20, the designs and/or software modules containing the designs 407, 408, 409, 410 and 411 can be customized. For example, customizable options for these designs include the intended training audience, the length and amount of training required, the training method utilized, and the technology requirements.

The Behavioral Observation Audit 513 is a web-enabled (i.e., Internet and/or Intranet) assessment tool that captures Sales Professionals' knowledge and behavior regarding interactions with healthcare providers. The Behavioral Observation Audit 513 contains both generic and product-specific questions in categories, where both categories and questions have been verified by the Product Working Teams. The Behavioral Observation Audit 513 also contains both Behavioral Observation Assessment and Instant Assessment questions. Customization of the Behavioral Observation Audits 513 can be performed (204 of FIG. 2) during the Customization of Tools and Processes portion 20.

Behavioral Observation Assessment questions are designed to capture a manager's direct observation of a Sales Professional's interactions with healthcare providers in the field and other on-the-job behaviors. Instant Assessment questions are targeted questions designed to capture a Sales' Professional's knowledge of interaction behaviors with healthcare providers and outstanding sales skills and behaviors, when those behaviors were not directly observed by the manager conducting the Behavioral Observation Audit. For example, in one particular embodiment of the instant invention, Behavioral Observation Audit 513 questions are scored on a three point rating scale:
Unacceptable—Professional fails to demonstrate knowledge, understanding, and/or practice of compliant behaviors.
Acceptable—Professional demonstrates knowledge, understanding, and practice of compliant behaviors.
Outstanding—Professional combines “Acceptable” compliance behaviors with strong selling skills.

Note that other grading systems can be used and still be within the scope and spirit of the instant invention.

Customizations options under the Customization Process 20 for the Behavioral Observation Audits 513 can also include a determination of whether both Behavioral Observation Assessment and Instant Assessment questions will be used, and whether all three points of the rating scale (or another scale) will be used. For example, a company may decide to only score question responses as “Unacceptable” or “Acceptable”.

Periodic updates to the Knowledge Webinars 303, Knowledge Tests 305, and Behavioral Observation Audits 513 will be required for reasons including but not limited to changes in company policy or procedure, changes in legislation or industry guidelines, and changes in a product's approved indications (205, 206 of FIG. 2). These changes will require reassembly or reformation of a Product Team and Legal Team to review, modify, and finalize changes to the Knowledge Webinars 303, Knowledge Tests 305, and Behavioral Observation Audits 513.

Knowledge Training and Testing:

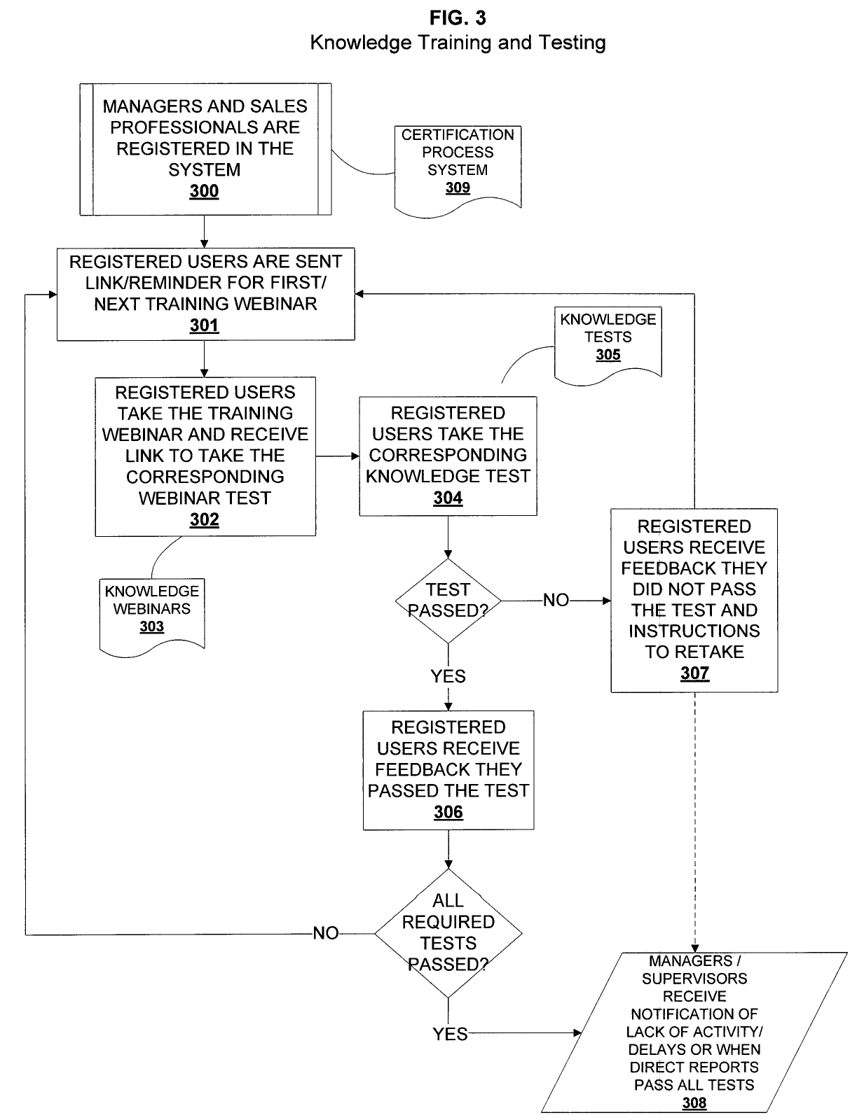

Referring now to FIGS. 1 and 3, the system of the instant invention includes a “Web-Based” or “Web-Enabled” Knowledge Training and Testing system, which as described herein, can be accessed via the Internet or a Company Intranet, or via another type of network, as desired. As shown in FIG. 3, Sales Managers and Sales Professionals are registered in the system 300. Registration occurs when the Sales Manager or Sales Representative responds to an email containing a Uniform Resource Locator (URL) that directs an Internet browser (or Intranet browser) to a web site that accesses a server containing (i.e., executing) the software module for the Certification Process System 309.

Registration captures relevant demographic information for managers and sales professionals in order to satisfy reporting requirements. Managers and sales professionals are provided with system passwords which enable them to access the Certification Process System 309 from a remote computer via the applicable network (i.e., Internet, Intranet, LAN, WAN).

Other employees of a company may also be registered to access the Certification Process System 309, as determined by the Project Team during the Customization of Tools and Processes 20, or thereafter. These employees may include but are not limited to representatives from compliance, legal, and sales operations. All employees who have completed the registration process will be hereafter referred to as Registered Users.

In one particular embodiment of the instant invention, following registration, Registered Users are sent a link (301 of FIG. 3) to access the first Knowledge Webinar 303 on the Certification Process System 309. When Registered Users have completed the first Knowledge Webinar 303, the Certification Process System 309 will send a link 302 to take the first Knowledge Test 305. After Registered Users take the first Knowledge Test 305, the Certification Process System 309 will score the test. “Passing” a Knowledge Test 304 is based on a threshold test score determined by the Project Team during the Customization of Tools and Processes 20 and/or updated thereafter. The system default for passing, in one particular embodiment of the instant invention, is 80% of items answered correctly.

If the Registered User achieves a score on the first Knowledge Test that is below the threshold passing score, the Certification Process System 309 gives them immediate feedback that they did not pass and instructions for retaking the Knowledge Webinar 303 and Knowledge Test 307. The Registered User is then again provided with a link to the Knowledge Webinar 303 corresponding to the Knowledge Test 305 they did not pass 301. The process of taking the Knowledge Webinar 303 and corresponding Knowledge Test 305 is repeated. See, 302, 304 of FIG. 3.

If the Registered User does achieve a score on the knowledge test that is above the threshold passing score, the Certification Process System 309 gives them immediate feedback that they passed the test 306. The Registered User is then sent the link to the next Knowledge Webinar 303 and the process of taking each Knowledge Webinar and accompanying Knowledge Test 305 is repeated until the Registered User has passed all required Knowledge Tests (301, 302, 304, 306). The number of required Knowledge Webinars is determined by the Product Working Teams and Legal Review Team during the Customization of Tools and Processes 20.

In the present particular embodiment, Managers/Supervisors receive automatic updates 308 when Registered Users:
Do not pass a Knowledge Test 305;
Have not responded to an email to take a Knowledge Webinar or Knowledge Test in an agreed upon timeframe; and/or
Have passed all required Knowledge Tests. See, 308 of FIG. 3.

Behavioral Learning Cascade:

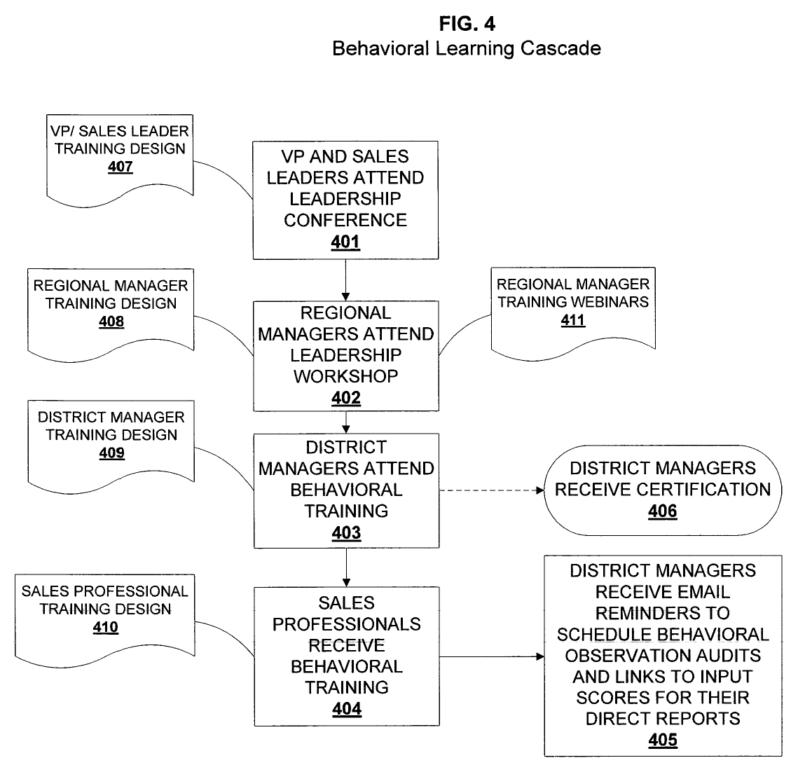

Referring now to FIGS. 1 and 4, as illustrated more particularly in FIG. 4, the Behavioral Learning Cascade 40 of the instant invention provides for the delivery of a series of computer accessible training modules, or, more preferably, in-person trainings (or a combination of the two) to descending levels of the organizational hierarchy starting with senior leadership (VP and Sales Leader training 401), continuing with management (Regional Managers 402 and District Managers 403), and ending with the field force (Sales Professionals 404). The designs for these meetings 407, 408, 409, 410 and the webinars for the Regional Manager Training 411 are all modified for the organization as required during the Customization of Tools and Processes 20.

The Leadership Conference training for VP and Sales Leaders 401 may include senior leaders from sales, marketing, legal, and any other key compliance stakeholders. The Leadership Conference 401, in one particular embodiment of the instant invention, can be produced as a single day of externally facilitated training to educate senior leaders on the system and method of the present invention, and to obtain agreement on the open issues decisions made by the Project Team, Product Working Teams, and Legal Teams, including the Behavioral Observation Audit (513 of FIG. 2) categories and questions and the key responsibilities for assessment and monitoring. However, during the Customization of Tools and Processes 20, or sometime thereafter, the length and/or content of this training may be modified.

During the Leadership Conference 401, senior leaders agree to the definitions of compliant selling and criteria for compliant sales success developed by the Product Working Teams (formed in 201 of FIG. 2). During the Leadership Conference 401, senior leaders also agree on specific accountabilities for each level of the sales organization for ensuring a continuous commitment to compliance and developing a “culture of compliance”, including deciding how success will be rewarded and making modifications to the company selling model as required.

In the present particular embodiment, the Leadership Workshop for Regional Managers 402 is intended to be as two, 2-hour webinars, supplemented by a half day of joint internal and externally facilitated training to prepare Regional Managers to lead their sales teams. This training is designed for the level of management over sales teams which consist of field managers or District Managers and their field force personnel or Sales Professionals. However, during the Customization of Tools and Processes 20, or thereafter, both the length and content of this training may be modified.

In the present embodiment, a first 2-hour Regional Manager Training Webinar 411 is preferably completed by Regional Managers prior to the designated half day facilitated training and provides an overview of the system and method of the present invention, Regional Managers' role during the Behavioral Learning Cascade 40, and Regional Managers' responsibilities during the Behavioral Observation Audit 50.

During the half day workshop 402, Regional Managers agreement is gained on the criteria for selling excellence identified by the Product and Legal Teams, the categories and questions of the Behavioral Observation Audit 513, and Regional Managers learn how to co-facilitate the District Manager training 403. The Regional Manager Leadership Workshop 402 is designed to be co-facilitated by senior leaders to help create a “culture of compliance” throughout the organization and ensure that training knowledge and skills are reinforced and retained. The District Manager Behavioral Training 403 is designed to be co-facilitated by Regional Managers to enable Regional Managers to better audit the performance of District Managers and also be able to conduct Behavioral Observation Audits of sales professionals, if required. During the Customization of Tools and Processes 20, or thereafter, the Project Team may also alter the facilitation of this training, for example, to determine whether co-facilitation occurs and who will fill this co-facilitation role, etc.

In the present preferred embodiment, following the half day workshop 402, Regional Managers complete a second, 2-hour Training Webinar 411, designed to enable Regional Managers to validate District Managers' monitoring and feedback of Sales Professionals during the Behavioral Observation Audit 50. The second Training Webinar 411 provides practice exercises in debriefing District Managers following the viewing of sample video vignettes of the District Managers coaching their Sales Professionals on Behavioral Observation Audit 513 outcomes.

The District Manager Behavioral Training 403, in one particular embodiment, includes a one day workshop co-facilitated by the Regional Managers to enable District Managers to conduct and provide feedback on the results of the Behavioral Observation Audit 513. This training is for the direct managers or supervisors of sales field force teams. However, during the Customization of Tools and Processes 20, or thereafter, the length, content, audience, and facilitation of this training may be modified.

During the District Manager Behavioral Training 403, District Managers are introduced to the system and method of the present invention, their role during the Behavioral Learning Cascade 40, and their responsibilities during the Behavioral Observation Audit 50. During the District Manager Behavioral Training 403, District Managers also agree to the definitions of compliant selling and criteria for compliant sales success developed by the Product Working Teams 201; commit to their role in creating a “culture of compliance”; learn to facilitate the training of their Sales Professionals on how to achieve compliant sales success and the requirements of the Behavioral Observation Audit process 50; are trained to conduct, score, and provide feedback and feedback to Sales Professionals on their interactions with Healthcare Providers using the Behavioral Observational Audit 513; and on the use of any additional sustainability tools recommended by the Project Team.

Following the District Manager Behavioral Training 403, District Managers receive Certification that they can facilitate the Sales Professional Behavioral Training 404.

In the instant embodiment, the Sales Professional Behavioral Training 404 includes a half day workshop facilitated by their District Manager to enable Sales Professionals to adapt their thinking and behavior to achieve compliant sales success. This training is for sales representatives who have direct contact with Healthcare Providers including but limited to physicians, physician assistants, pharmacists, administrators, and third party payers. However, during the Customization of Tools and Processes 20, or thereafter, the length, content, audience, and facilitation of this training may be modified.

Additionally, during the Sales Professional Behavioral Training 404, Sales Professionals practice and receive feedback on how to apply content from the Knowledge Webinars 303 to real world interactions with Healthcare Providers; learn the definitions and behavior for compliant sales excellence identified by the Product Teams for their assigned products 201; practice the application of compliant sales excellence during case study discussions and behavioral exercises; and learn the requirements of the Behavioral Observation Audit process 50.

Once District Managers have facilitated Sales Professional Behavioral Training 404 for their direct reports, The District Managers are sent reminders (i.e., via email, voicemail, SMS, Text message, etc.) to schedule a Behavioral Observation Audit with each of their direct report Sales Professionals 405. District Managers are also sent a computer link to input the scores and findings from the Behavioral Observation Audit 513 for their direct reports 405 into a computerized form, the fields of which are stored on a server holding part or all of the system of the present invention. Such computerized form can be accessed via a network and/or through the Internet/Company Intranet, as desired. In one particular embodiment, the computer link directs the user to a website, via the Internet, wherein the user enters the information into fields of the form.

Behavioral Observation Audit:

Referring now to FIGS. 1, 2 and 5, the Behavioral Observation Audit process 50 begins when a District Manager schedules a field observational audit, or opportunity to accompany and observe a Sales Professional in the performance of their job duties 501. It is desirable that the Behavioral Observation Audit 513 should be scheduled to occur at such a time that the District Manager will have an opportunity to view as many of their Sales Professional's interactions with Healthcare Providers and other duties as possible.

A Behavioral Observation Audit 513 is designed for use within the Certification Process System 309, however, during the Customization of Tools and Processes 20, or thereafter, the Project Team may modify the role of the Certification Process System 309 in the administration of the Behavioral Observation Audit 513.

In association with the Certification Process System 309 of one particular embodiment of the instant invention, the District Manager will conduct a Behavioral Observation Audit, as spelled out in the Behavioral Observation Audit 513, score the results, and input these results to a computerized database associated with the server containing the Certification Process System 309. Preferably, such a report is entered within an agreed upon period as determined by the Project Team (default is 45 days following Sales Professional Behavioral Training 404). In one particular embodiment, the results of the Behavioral Observation Audit can be entered into the database by entering information into the database via a computerized form accessible via a website. Alternately, the District Manager may use an electronic handheld device to record the results of the Behavioral Observation Audit 513 as they occur, with these results being uploaded, subsequently or in real-time, to a database of the Certification Process System 309. If the assessment does not occur in the agreed upon time frame, a report can be sent by the system of the present invention to the supervisor of the District Manager (e.g., Regional Manager) for follow up with the District Manager to ensure that the assessment is performed 512.

The Behavioral Observation Audit 513 is conducted during a field observation of a Sales Professional 502 which includes, but is not limited to, the following duties: scheduling a visit, visiting or other direct interaction with Healthcare Providers, and planning or facilitating a speakers program. The Behavioral Observation Audit 513 is traditionally conducted by the direct supervisor of the Sales Professional (District Manager) but it can also be conducted by any District Manager or a Regional Manager because of design of the Behavioral Training Cascade 40 and the Behavioral Observation Audit 513. Regional Managers are fully versed on conducting and scoring the Behavioral Observation Audit 513 because they co-facilitate the District Manager training, and any manager can conduct and score the Behavioral Observation Audit 513 because the scoring of the questions is done with behavioral anchors.

The Behavioral Observation Audit 513 contains two types of questions, Behavioral Observation Assessments, designed to assess observed behavior, and Instant Assessment items, designed to assess knowledge. The content of the Behavioral Observation Audit 513 includes the District Manager's direct observation of a Sales Professional's interactions with healthcare providers in the field and other on-the-job behaviors and scoring these behaviors using the behaviorally anchored rating scales from each Behavioral Observation Audit 513 Assessment item. Where the District Manager did not have an opportunity to directly observe a behavior on a given field observation audit, the corresponding Instant Assessment question is posed to the Sales Professional to assess their knowledge and their answer is recorded and scored according to the scale provided for each Instant Assessment item. Scoring can be customized by the Project Team during the Customization of Tools and Processes 20, with the default scoring being, in one particular embodiment, 1 points for “Unacceptable” responses, 2 point for “Acceptable” responses, and 3 points for “Outstanding” responses. A percentage score out of 100% is then calculated by dividing the Sales Professionals obtained score by the total possible score (i.e., total number of items multiplied by three).

Following the performance and scoring of the Behavioral Observation Audit 502 a computerized module of the Certification Process System 309 will generate and distribute Customized Reports 514 for monitoring and trend analysis 503, as specified by the Project Team during the Customization of Tools and Processes 20, or thereafter. These reports provide immediate, “lead indicator” early alerts of aggregate field force knowledge gaps, critical compliance risks and other key field force trends. The distribution list for Customized Reports 514 may include but is not limited to CEO, VP/Sales Leaders, Regional Managers, District Managers, Chief Compliance Officer and other compliance officers, and Legal and Regulatory officials. These Customized Reports 514 may include but are not limited to reports of single or multiple assessments of a single Sales Representative, summary reports across direct reports for a District Manager, summary reports across District Managers for a Regional Managers, and summary reports of all unacceptable responses by Manager or time period 503.

Also following the conduct and scoring of the Behavioral Observation Audit 502, if there are any items that were scored as “Unacceptable” the Certification Process System 309 is programmed to send the following: a reminder email to the District Manager to provide feedback and coaching to their Sales Representative 505; a report to the Regional Manager supervisor of the District Manager to verify the District Manager did follow up with their Sales Professional 504. In addition, if there are “Unacceptable” rating on any items labeled as violations by the Product Teams during the Customization of Tools and Processes 20, the Certification Process System 309 can be programmed, if desired, to send immediate notification to identified compliance personnel. Further, in one particular embodiment, if the Sales Professional being assessed by the Behavioral Observation Audit 513 was previously Certified, their Certification will be considered suspended 506 and this suspension will not be lifted until they have completed a Behavioral Observation Audit 513 with no items scored “Unacceptable”. This procedure can be modified by the Project Team to provide a different procedure.

If the District Manager then provides feedback and coaching to the Sales Representative who had “Unacceptable” items on their Behavioral Observation Audit, the District Manager creates a development plan and provides coaching to the Sales Representative 507, using the behavioral anchors provided in the Behavioral Observation Audit 513 and any other development and sustainability tools as specified by the Project or Product Team during the Customization of Tools and Processes 20. The purpose of this feedback and coaching is to train and reinforce outstanding selling excellence behaviors so the Sales Professional understandings why their response was “Unacceptable” and how they could have achieved a rating of “Outstanding”. The District Manager documents this coaching in the system of the present invention 510.

If the District Manager does not provide feedback and coaching to the Sales Representative who had “Unacceptable” items on their Behavioral Observation Audit within the time frame specified by the Project Team during the Customization of Tools and Processes 20, the system of the present invention sends an email notification to the Regional Manager supervisor of the District Manager to prompt the District Manager to follow up with their Sales Professional 504.

Alternately, following the performance and scoring of the Behavioral Observation Audit 502, if there are no items that were scored as “Unacceptable”, the Sales Professional is considered to have passed the Audit. In the instant embodiment, if all items on the Behavioral Observation Audit 513 were scored as “Outstanding”, the District Manager schedules the next Behavioral Observation Audit assessment 511 within the time frame agreed upon by the Project Team during the Customization of Tools and Processes 20. For example, Behavioral Observation Audits 50 may be performed quarterly for each Sales Representative. However, if the Sales Professional passed, but not all items on the Behavioral Observation Audit 513 were scored as “Outstanding”, then the District Manager provides coaching to their Sales Representative on how they could have achieved a score of “Outstanding” on the items 509, using the behavioral anchors provided in the Behavioral Observation Audit 513 and any other development and sustainability tools as specified by the Project or Product Team during the Customization of Tools and Processes 20. The purpose of this feedback and coaching is to train and reinforce outstanding selling excellence behaviors so the Sales Professional understand why their response was not “Outstanding” and how they could have achieved a rating of “Outstanding”. Note that, in other types of scoring systems, such as, in systems using only two levels of rating, the District Manager can use the behavioral anchors and any other development and sustainability tools for feedback and coaching to reinforce selling excellence behaviors.

The District Manager documents this coaching in the Certification Process System 309,510, which documentation is stored in a database of that System 309, and the District Manager schedules the next Behavioral Observation Audit assessment 511 within the time frame agreed upon by the Project Team during the Customization of Tools and Processes 20. For example, Behavioral Observation Audit process 50 may be performed quarterly for each Sales Representative.

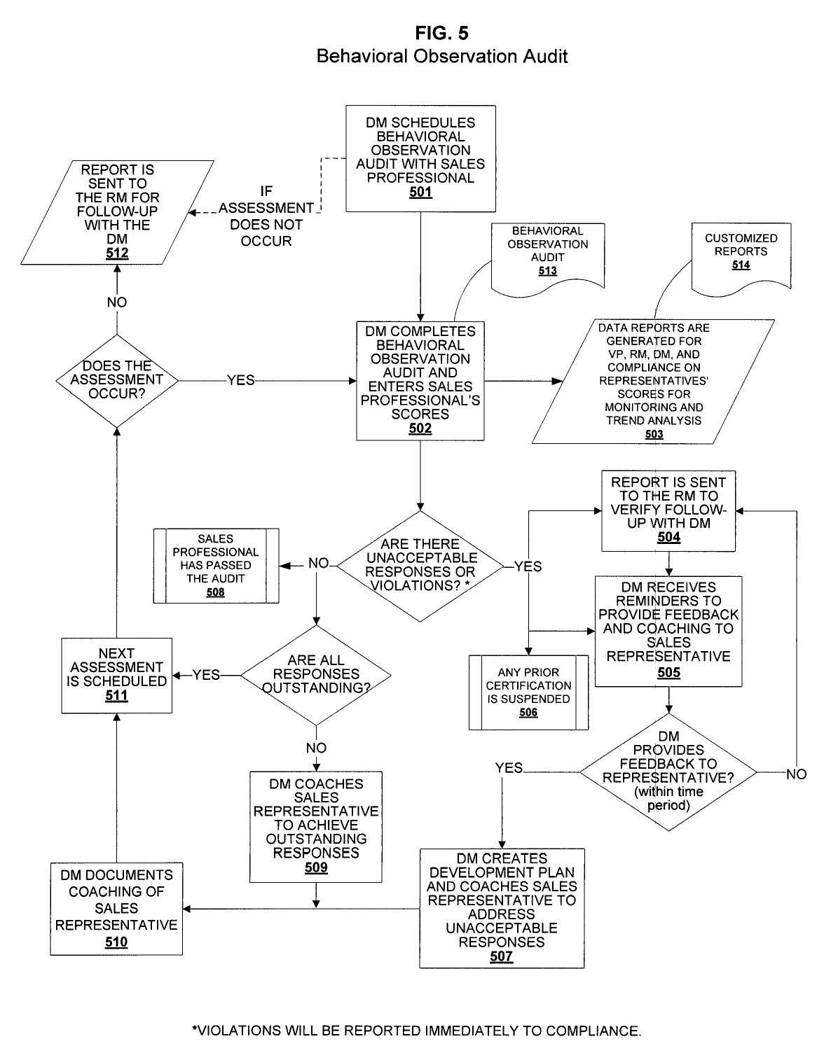

If the next assessment occurs as scheduled, then the Behavioral Observation Audit process is repeated from box 502 of FIG. 5. If the assessment does not occur, the Certification Process System 309 of the instant embodiment is programmed to send a notification to the supervisor of the District Manager (e.g., Regional Manager) to follow up with the District Manager and ensure the assessment is performed 512.

Sales Professional Certification:

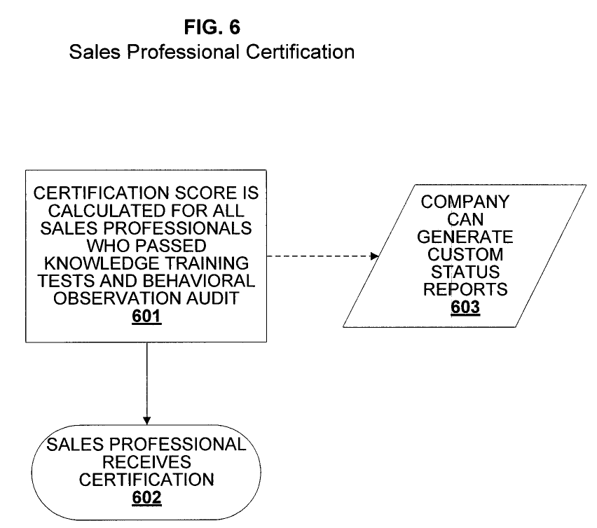

Referring now to FIGS. 1, 2 and 6, when a Sales Professional has successfully completed all Knowledge Tests 305 and passed the Behavioral Observation Audit 513, a Certification Score is calculated for that Sales Professional 601 as specified by the Project Team during the Customization of Tools and Processes 20, or thereafter. In one particular embodiment of the present invention, the mathematical average of the Knowledge Tests 305 and the Behavioral Observation Audit 513 score is calculated. If this average exceeds a particular threshold set by the Project Team, the Sales Professional is considered Certified and receives notice 602 of that Certification. Using the System 309 of the instant invention, the company can generate any number of custom reports 603 of Certification scores, for example, by individual, district, or region, as specified by the Project Team during the Customization of Tools and Processes 20, or thereafter. These reports can also be tied to company reward structures at the individual or sales team level to encourage “Outstanding” performance on the Behavioral Observation Audits 513.

Annual Re-Certification:

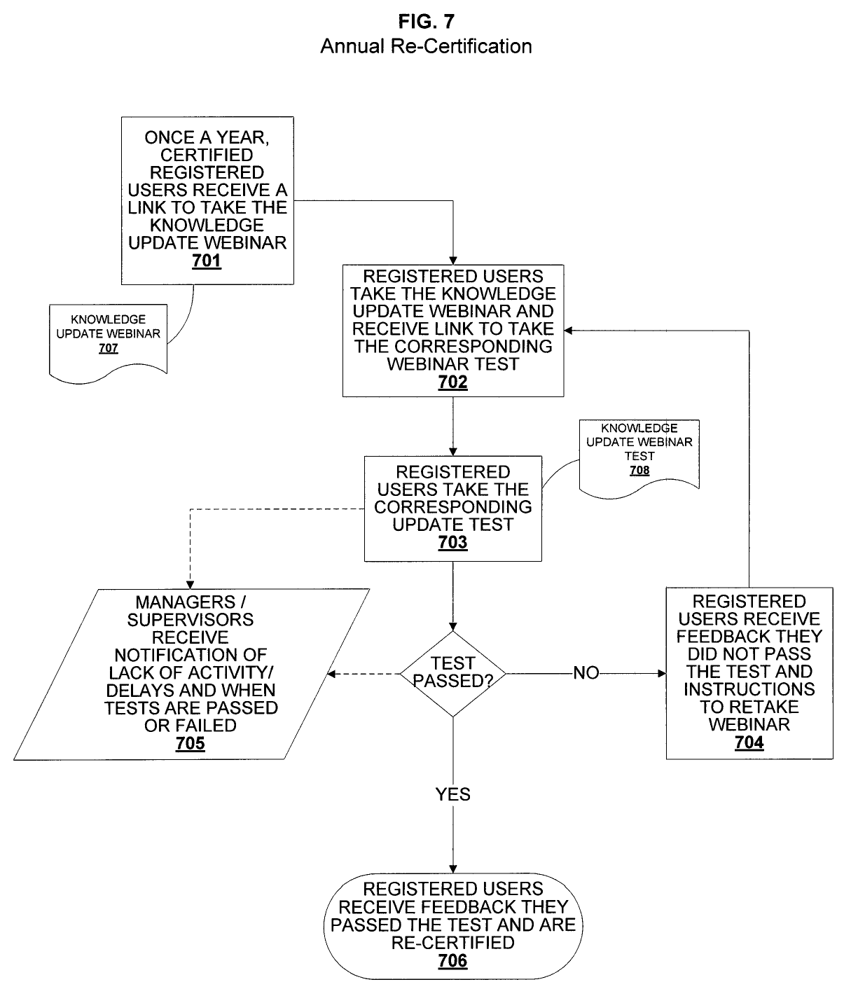

Referring now to FIGS. 1, 2 and 7, re-certification must occur at defined intervals. In the present preferred embodiment, such re-certification is desirably performed once a year. Thus, once a year, Certified Registered Users are sent a link 701 to access a Knowledge Update Webinar 707. Certified Registered Users may include, but are not limited to, Sales Professionals and Managers.

In one particular embodiment of the instant invention, the Knowledge Update Webinar 707 is part of the Certification Process System 309 (i.e., accessible on the same server as the Certification Process System 309) and contains updated information on corporate, local, and national level compliance policies and regulations, including any updates related to particular products, if applicable. If desired, the Knowledge Update Webinar 707 can be validated by the Legal Review Team before posting. Also, in the instant embodiment, the Knowledge Update Webinar 707 preferably includes state-of-the-art e-learning features, including a voice-over that provides a detailed explanation of the content. The Knowledge Update Webinar 707 is designed for on-line use, but can also be remotely downloadable for off-line and self-paced learning.

Additionally, in the instant embodiment, Product-specific knowledge and behavior updates can be provided through regular Behavioral Observation Audit 513 updates 206. If desired, the involvement of the Certification Process System 309 in providing the Knowledge Updates and the specific content of these updates can be determined by the Project Team during the Customization of Tools and Processes 20, or thereafter.

After accessing and viewing the Knowledge Update Webinar 707, Registered Users are sent a link 702 to electronically access the corresponding Knowledge Update Webinar Test 708, stored with (i.e., as part of) the Certification Process System 309. The construction of the Knowledge Update Webinar Test 708 employs testing best practices to ensure psychometrically valid test and certification process outcomes. For example, each Knowledge Update Webinar Test 708 item is dynamically created from a large question pool stored in a database of the Certification Process System 309. All Knowledge Update Webinar Test 708 items can be validated by the Legal Review Team.

After Certified Registered Users take the Knowledge Update Webinar Test 708, the Certification Process System 309 will score the test 703. “Passing” the Knowledge Update Webinar Test 708 is based on a threshold test score determined by the Project Team during the Customization of Tools and Processes 20. In one preferred embodiment of the instant invention, the system default for passing is 80% of items answered correctly.

If the Certified Registered User achieves a score on the Knowledge Update Webinar Test 708 that is below the threshold passing score, the Certification Process System 309 gives them immediate feedback that they did not pass the test and instructions to retake the Knowledge Update Webinar 707 and Knowledge Update Webinar Test 708.

If the Certified Registered User achieves a score on the Knowledge Update Webinar Test 708 that is above the threshold passing score, the Certification Process System 309 gives them immediate feedback that they passed the test and they are re-certified in the Certification Process System 309, 706.

Managers receive automatic updates 705 when sales professionals:
Do or do not pass the Knowledge Update Webinar Test 708; or
Have not responded to an email to take the Knowledge Update Webinar 707 or Knowledge Update Webinar Test 708 in an agreed upon timeframe.

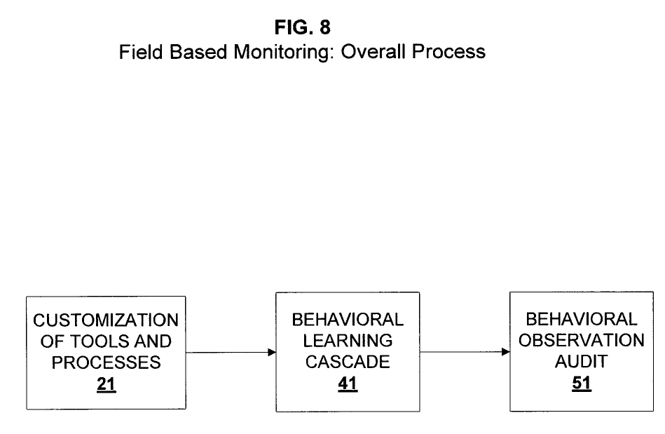

Although the foregoing system has been described in connection with a first overall process of FIG. 1, other possible processes can be implemented within the spirit of the instant invention. For example, referring now to FIG. 8, there is shown a system and method for field based compliance monitoring in accordance with another embodiment of the instant invention.

Method for Field Based Compliance Monitoring:

Field Based Compliance Monitoring, as shown in FIG. 8, can be implemented as a stand-alone program for defining, monitoring, coaching, and reporting compliant pharmaceutical sales excellence. It integrates a company's existing compliance knowledge training with customized behavioral training, assessment, coaching, and monitoring to ensure application of compliant selling skills in the field. The Field Based Compliance Monitoring System of FIG. 8 includes a Customization of Tools and Processes stage 21, a Behavioral Learning Cascade stage 41 and a Behavioral Observation Audit stage 51. Note that more or fewer stages can be included in the process without deviating from the spirit of the instant invention.

Referring now to FIGS. 8-11, the Customization of Tools and Processes stage 21, a Behavioral Learning Cascade stage 41 and a Behavioral Observation Audit stage 51 are similar in most respects to the Customization of Tools and Processes System 20, the Behavioral Learning Cascade stage 40 and a Behavioral Observation Audit stage 50 of FIGS. 1, 2, 4 and 5, above, with like reference numbers representing like parts/steps. As such, items in FIGS. 8-11 carrying the same reference numbers as their counterparts in FIGS. 1, 2, 4 and 5, will not be separately described, except where they differ from those counterparts. In particular, one main difference between the System of FIG. 8 and that of FIG. 1 is that, in the instant preferred embodiment, the system of FIG. 8 does not include the Knowledge Training and Testing stages of FIGS. 1-7.

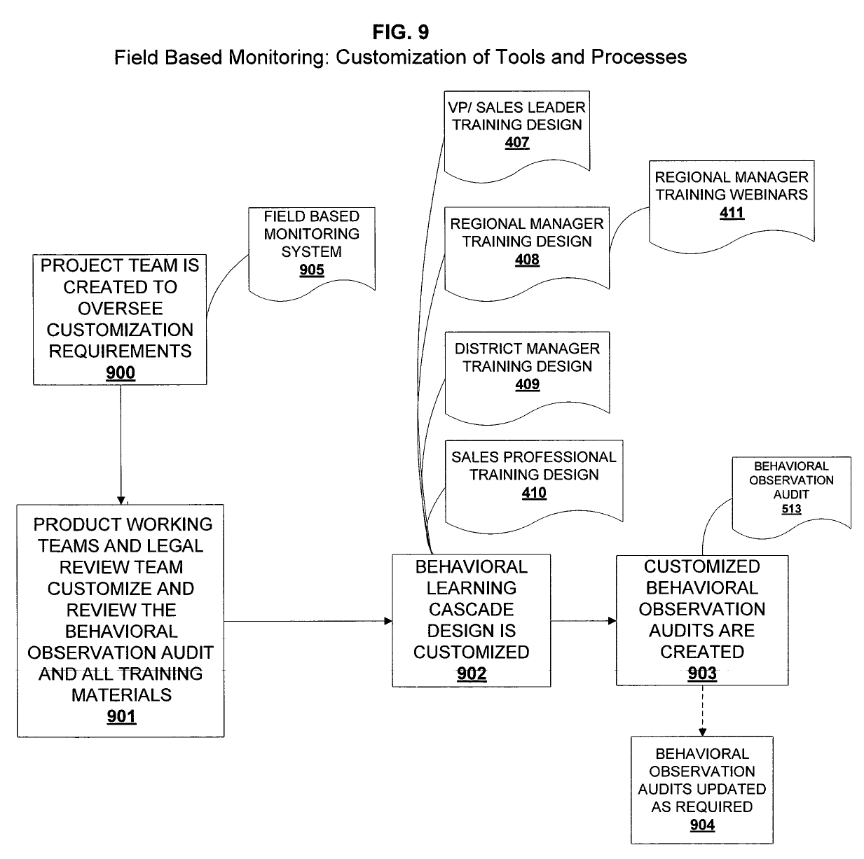

For example, the Customization of Tools and Processes System 21 of FIG. 8 includes the creation of a Project team to oversee customization requirements 900 of the Field Based Monitoring System 905 that is substantially the same as that described in connection with 200 of FIG. 2 for the Certification Process System 309 of FIG. 2. Similarly, the stages 901, 902, 903 and 904 of FIG. 9 substantially correspond to those described in connection with stages 201, 203, 204 and 206 of FIG. 2, respectively. Note however, that the Customization of Tools and Processes System 21, illustrated in greater detail in FIG. 9, does not include systems or stages corresponding to the Knowledge Webinars 303 of FIG. 2, the Knowledge Tests 305 of FIG. 2, or the creation or updating of those Webinars and Tests of 202 and 205 of FIG. 2. Rather, these portions of the Certification Process System 309 of FIGS. 1 and 2 are omitted from the Field Based Monitoring System 905 of FIGS. 8 and 9.

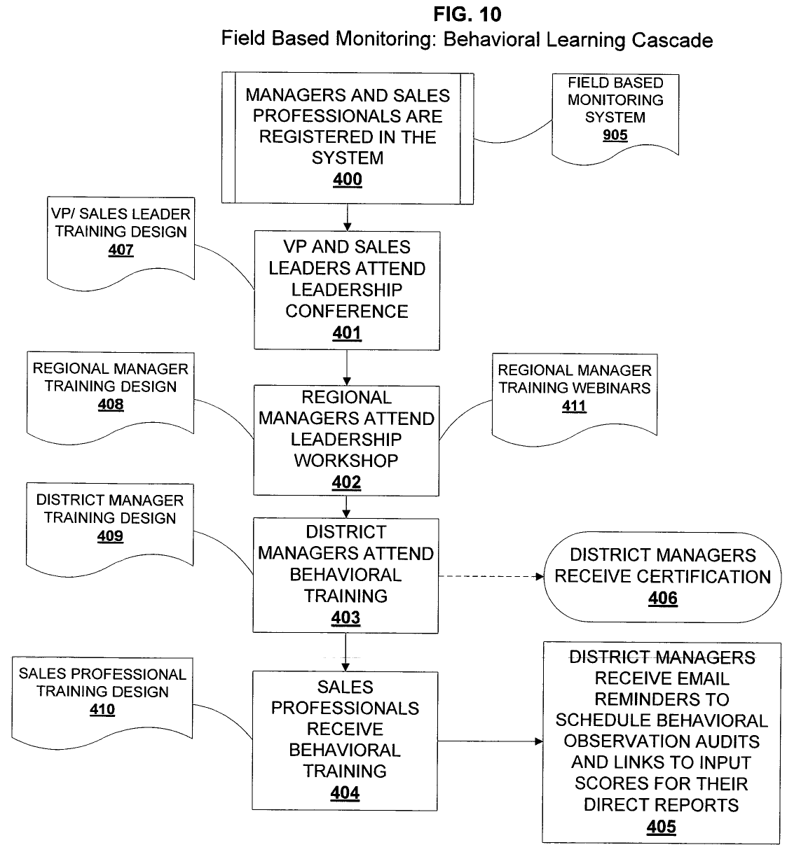

Similarly, as shown in FIG. 10, Managers and Sales Professionals are Registered 400 in the Field Based Monitoring System 905. Registration occurs when the Sales Manager or Sales Representative responds to an email containing a Uniform Resource Locator (URL) that directs an Internet browser to a web site that accesses a server containing the Field Based Monitoring System 905.

Registration captures relevant demographic information for managers and sales professionals in order to satisfy reporting requirements. Managers and sales professionals are provided with system passwords which enable them to access the Field Based Monitoring System 905 from any computer with internet capabilities.

Thereafter, the Behavioral Learning Cascade of FIG. 10 operates in the same way as is described in connection with the Behavioral Learning Cascade of FIG. 4, with like reference numbers describing like systems/processes. Note that, in the present preferred embodiment, the Field Based Monitoring System 905 of FIG. 10 still provides the Regional Managers with the Regional Manager Training Webinars 411, as described in connection with FIG. 4, above.

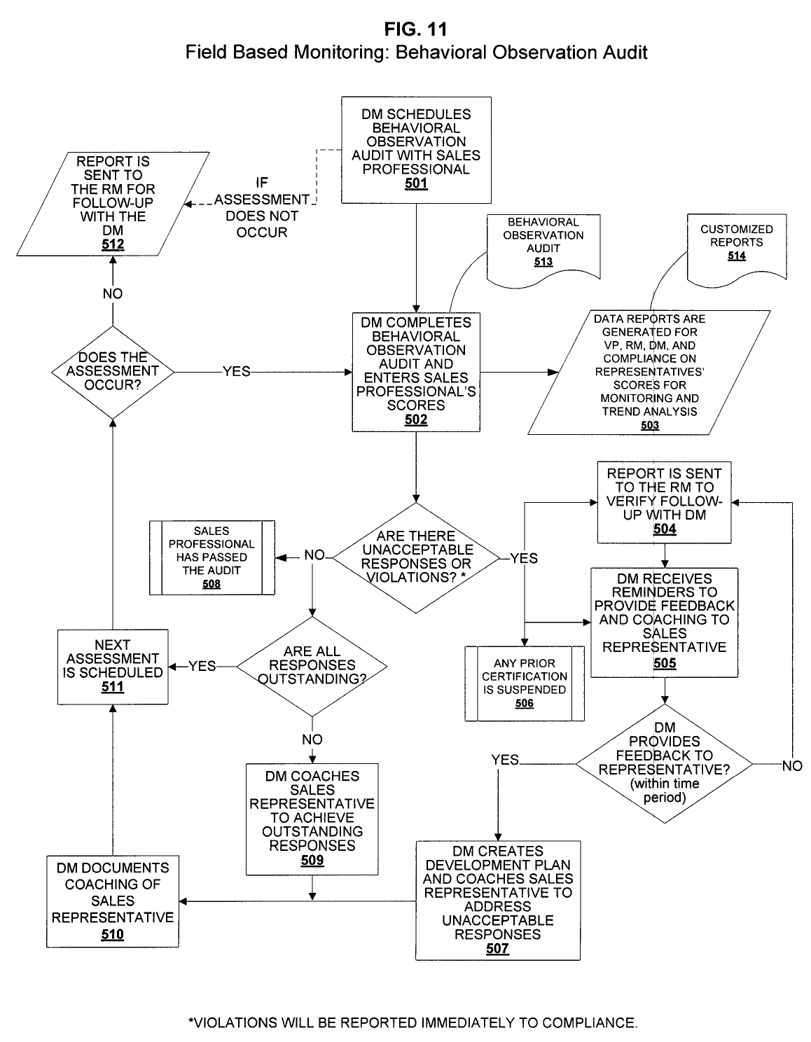

Additionally, the Behavioral Observation Audit 51 of the Field Based Monitoring System 905 of FIGS. 8 and 11 are conducted in a substantially identical manner to those described in connection with the Compliance Monitoring System 309 of FIGS. 1 and 5, with like reference numbers describing like systems/processes.

Additionally, if desired, any embodiment of the instant invention, including those described in connection with FIGS. 1-11, can incorporate and provide access to an Academic Medical Center Online Database, as will be described herebelow.

Academic Medical Center Online Database:

In particular, in one preferred embodiment of the instant invention there is provided The Academic Medical Center Online Database that is a comprehensive database of the visitation and conduct policies for Academic Medical Centers (AMCS) that resides in a computer readable medium, and is accessible by a computer interface. In a preferred embodiment, the interface is accessed via the Internet, although other vehicles/networks for accessing the interface are described herein.

Each AMC folder contains:
1. A job aid summary of the policy and required actions pertaining to pharmaceutical professionals, interactions with staff; and
2. A copy of the original policy documents with website links where provided.

The Academic Medical Center Online Database is accessed, in one particular embodiment, through an Internet link to the database. Other connections, such as LAN, WAN, Intranet, etc., can be used, too. Users select AMC folders to download based on the name of the AMC.

The Academic Medical Center Online Database could also be integrated into the process of the present invention as represented in FIGS. 1 and/or 8 such that Sales Professionals would specify AMCs under their territory or responsibility at registration (300 of FIG. 1; 400 of FIG. 9) and would download and review the policies for all assigned AMCs when accessing the Certification Process System 309 of FIGS. 1 and 2 or the Field Based Monitoring System 905 of FIGS. 8 and 9 and/or to take Knowledge Webinars 302, 303 of FIG. 2 (only in the embodiment of FIG. 1).

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method for performing a behavioral observation audit, comprising the steps of:
customizing the behavioral observation audit process to at least one of a particular product, a particular company and a particular industry;
performing the behavioral observation audit in accordance with the customized behavioral audit process; and
utilizing the results of the behavioral observation audit to generate a report.

2. The method of claim 1, wherein the customizing step is performed using a computer specifically programmed to customize and create a customized behavioral observation audit process.

3. The method of claim 1, wherein the performing step is performed by an observer based on the customized behavioral audit process, the observations of the observer being entered into a computer specifically programmed to utilize the observations to generate the report.

4. The method of claim 1, wherein the customizing step and the utilizing step are performed by a computer specifically programmed to customize the behavioral observation audit process in accordance with user determined guidelines and to generate reports based on results gathered based on the behavioral observation audit process.

5. The method of claim 4, wherein the performing step is performed by an observer based on the customized behavioral audit process.

6. The method of claim 5, wherein the customizing step customizes the behavioral observation audit in accordance with a set of industry standard guidelines.

7. The method of claim 6, wherein the behavioral audit process is used to determine the compliance of a pharmaceutical sales representative with the industry standard guidelines.

8. The method of claim 1, wherein the behavioral observation audit is customized to at least one of a pharmaceutical product, a pharmaceutical company and a specific field of the pharmaceutical industry.

9. The method of claim 8, wherein the behavioral observation audit is customized to a particular pharmaceutical product.

10. The method of claim 9, wherein the behavioral audit process is customized in accordance with industry standard rules.

11. The method of claim 10, further comprising the step of: providing knowledge training relating to compliance with the industry standard.

12. The method of claim 11, further comprising the step of: testing an individual on the knowledge training provided.

13. A method for certifying compliance with a pharmaceutical industry standard, comprising the steps of:
customizing a behavioral observation audit process to at least one of a particular product, a particular company and a particular industry;
performing the behavioral observation audit in accordance with the customized behavioral audit process; and
utilizing the results of the behavioral observation audit to generate a report.
